(19) United States
(12) Patent Application Publication
(10) Pub. No.: US 2025/0096545 A1
(43) Pub. Date: Mar. 20, 2025

(54) CUTOUT COVER WITH REMOVABLE INSERT

(71) Applicant: Hubbell Incorporated, Shelton, CT (US)

(72) Inventor: Paul Alfaro, Orange, CA (US)

(21) Appl. No.: 18/882,933

(22) Filed: Sep. 12, 2024

Related U.S. Application Data
(60) Provisional application No. 63/582,580, filed on Sep. 14, 2023.

(51) Int. Cl. H02G 7/00; H01H 85/165

(52) U.S. Cl. CPC H02G 7/00; H01H 85/165

(57) ABSTRACT

A cover for a distribution system circuit interrupting device having a top portion and an outer wall. The outer wall defining an interior. The outer wall having a first side portion, a second side portion, a rear portion, and a front opening. The rear portion configured to receive a distribution system insulator and the front opening configured to permit rotation of a fuse device from the interior to an exterior of the outer wall. An insert is positioned in the interior. The insert configured to releasably engage an insulator to connect the outer wall to the insulator.

### RELATED APPLICATION(S)

This application claims priority to U.S. Provisional Application No. 63/582,580, filed Sep. 14, 2023, the disclosure of which is hereby incorporated by reference in its entirety.

### FIELD

Various exemplary embodiments relate to fuse devices for power distribution systems.

### BACKGROUND

Circuit interrupting devices, such as circuit breakers, sectionalizers, cutouts, and reclosers provide protection for power distribution systems and the various apparatus on those power distribution systems such as transformers and capacitor banks by isolating a faulted section from the main part of the system. A fault current in the system can occur under various conditions, including but not limited to lightning, an animal or tree shorting the power lines or different power lines contacting each other. Conventional circuit interrupting devices sense a fault and interrupt the current path. Conventional reclosers also re-close the current path and monitor continued fault conditions, thereby re-energizing the utility line upon termination of the fault. This provides maximum continuity of electrical service. If a fault is permanent, the recloser remains open after a certain number of reclosing operations that can be pre-set.

A fuse cutout is a combination of a fuse and a switch that is actuated by an overcurrent event. An overcurrent caused by a fault in the transformer or customer circuit will cause the fuse to melt, disconnecting the transformer from the line. To facilitate disconnection, cutouts are typically mounted about 20 degrees off vertical so that the center of gravity of the fuse holder is displaced and the fuse holder will rotate and fall open under its own weight when the fuse blows. Mechanical tension on the fuse link normally holds an ejector spring in a stable position. When the fuse blows, the released spring pulls the stub of the fuse link out of the fuse holder tube to reduce surge duration and damage to the transformer and fuse holder to quench any arc in the fuse holder. The cutout can also be opened manually by utility linemen standing on the ground and using a long insulating stick called a “hot stick”.

A cutout can include three major components. The first component is the cutout insulator body, a generally open C-shaped frame that includes a conductive top hood piece and a conductive bottom hinge pieces which cooperate to accept a fuse holder as well as a ribbed porcelain or polymer insulator main portion that electrically isolates the conductive portions from the support bracket to which the insulator is fastened via a centrally extending mounting flange.

The second component is the fuse holder itself, also called the “fuse tube”, that is an insulating tube which contains the replaceable fuse element. When the fuse element operates (“melts”), the fuse holder subsequently drops out of the upper contact of the top hood of the insulator body, breaking the circuit, and hangs from a hinge on its lower end that cooperates with the bottom hinge of the insulator body via a pinion. The hanging fuse holder provides a visible indication that the fuse has operated and assurance that the circuit is open. The circuit can also be opened manually by pulling out the fuse holder using a hot stick with approved load break device.

The third component is the fuse element, or “fuse link”, which is the replaceable portion of the cutout assembly that operates when the electrical current is great enough. In operation, after the fuse link has blown and the fuse holder drops, a lineman replaces the fuse link and re-deploys the fuse tube in its operating condition between the conductive top hood and bottom hinge pieces of the fuse cutout insulator body. The fuse holder can be equipped with a pull ring that can be engaged by a hook at the end of the fiberglass hot stick operated by a lineworker standing on the ground or from a bucket truck, to manually close/open the switch.

In certain installations, a cover can be provided for the cutout which are used to protect the wildlife from interfering with the cutout and potentially disrupting the electrical grid. There exists a variety of covers for this use, including hinged two-piece covers and one-piece snap on covers. These covers may be installed remotely by one or more users.

### SUMMARY

In certain configurations, a circuit interrupting device includes a removable insert for engaging an insulator.

In certain configurations, a removable insert includes an upper portion, a lower portion, and an inner edge configured to engage an insulator of a fuse device.

In certain configurations, a circuit interrupting device includes a removable insert for engaging an insulator positioned in a cover where the insert has a hardness less than the cover.

In certain configurations, a circuit interrupting device includes a removable insert for engaging an insulator positioned in a cover where the insert has at least one flexure.

In certain configurations, a cover for a distribution system circuit interrupting device having a top portion and an outer wall. The outer wall defining an interior. The outer wall having a first side portion, a second side portion, a rear portion, and a front opening. The rear portion configured to receive a distribution system insulator and the front opening configured to permit rotation of a fuse device from the interior to an exterior of the outer wall. An insert is positioned in the interior. The insert configured to releasably engage an insulator to connect the outer wall to the insulator.

In certain configurations, a cover for a distribution system circuit interrupting device having a top portion and an outer wall. The outer wall defining an interior. The outer wall having a first side portion, a second side portion, a rear portion, and a front opening. The rear portion configured to receive a distribution system insulator and the front opening configured to permit rotation of a fuse device from the interior to an exterior of the outer wall. An insert is positioned in the interior. The insert configured to releasably engage an insulator to connect the outer wall to the insulator. A base extends between the first side portion and the second side portion of the outer wall and the insert is received in the base.

In certain configurations, a cover for a distribution system circuit interrupting device having a top portion and an outer wall. The outer wall defining an interior. The outer wall having a first side portion, a second side portion, a rear portion, and a front opening. The rear portion configured to receive a distribution system insulator and the front opening configured to permit rotation of a fuse device from the interior to an exterior of the outer wall. An insert is positioned in the interior. The insert configured to releasably engage an insulator to connect the outer wall to the insulator. A base extends between the first side portion and the second side portion of the outer wall and the insert is received in the base. The base includes a central aperture, a forward slot extending from a front opening to the central aperture, and a rear slot extending from the central aperture toward the rear portion of the cover.

In certain configurations, a cover for a distribution system circuit interrupting device includes a top portion having a first top wall and a second top wall. A first set of fingers extend from the first top wall. A second set of fingers extend from the second top wall. A first flap extends from the first top wall. A second flap extends from the second top wall. The first and second flaps are configured to cover a slot. An outer wall extends from the top wall. The outer wall defines an interior. The outer wall has a first side portion, a second side portion, a rear portion, and a front opening. The rear portion is configured to receive a distribution system insulator and the front opening is configured to permit rotation of a fuse device from the interior to an exterior of the outer wall.

In certain configurations, an insert for a distribution system circuit interrupting device includes an upper portion having a planar portion extending in a first plane. A lower portion has a planar portion extending in a second plane opposite the first plane. An outer edge extends between the upper portion and the lower portion. An inner edge extends between the upper portion and the lower portion. The lower portion is configured to engage a support of a fuse device. The inner edge defines an aperture configured to receive an insulator body of a fuse device.

In certain configurations, an insert for a distribution system circuit interrupting device includes an upper portion having a planar portion extending in a first plane. A lower portion has a planar portion extending in a second plane opposite the first plane. An outer edge extends between the upper portion and the lower portion. An inner edge extends between the upper portion and the lower portion. The lower portion is configured to engage a support of a fuse device. The inner edge defines an aperture configured to receive an insulator body of a fuse device. A flexure is spaced from the central aperture.

In certain configurations, an insert for a distribution system circuit interrupting device includes an upper portion having a planar portion extending in a first plane. A lower portion has a planar portion extending in a second plane opposite the first plane. An outer edge extends between the upper portion and the lower portion. An inner edge extends between the upper portion and the lower portion. The lower portion is configured to engage a support of a fuse device. The inner edge defines an aperture configured to receive an insulator body of a fuse device. A resilient member extends into a front opening.

### BRIEF DESCRIPTION OF THE DRAWINGS

The aspects and features of various exemplary embodiments will be more apparent from the description of those exemplary embodiments taken with reference to the accompanying drawings.

FIG. 1 is a side perspective view of a fuse cutout.

FIG. 2 is a side perspective view of the fuse cutout of FIG. 1 with a cover installed.

FIG. 3 is a side perspective view of the cover of FIG. 2.

FIG. 4 is a rear perspective view of the cover of FIG. 2.

FIG. 5 is a front perspective view of the cover of FIG. 2.

FIG. 6 is an enlarged, partial perspective view of the interior of the cover of FIG. 2.

FIG. 7 is a top perspective view of an insert for the cover of FIG. 2.

FIG. 8 is a bottom perspective view of the insert of FIG. 7.

FIG. 9 is a front perspective view of an alternative cover and insert.

FIG. 10 is an enlarged, partial perspective view of the interior of the cover of FIG. 9.

FIG. 11 is a top perspective view of an insert for the cover of FIG. 9.

FIG. 12 is a bottom perspective view of the insert of FIG. 11.

FIG. 13 is an enlarged, partial top view of the insert of FIG. 9.

### DETAILED DESCRIPTION OF EXEMPLARY CONFIGURATIONS

Certain exemplary configurations are directed to a cover for a fuse device used in a power distribution system. The fuse device can be connected to an overhead power line system, for example being connected to a utility pole, either directly or through one or more mounting brackets. The fuse device can be configured to disconnect from the power distribution system when a certain condition occurs, for example one or more overcurrent fault conditions. The fuse device can be reconnected to the power distribution system by a lineman or other technician.

In certain operations, the lineman will engage the fuse device with a hot stick. Hot sticks typically include a pole made from an insulated material such as fiberglass. Hot sticks can have different lengths, ranging from about 6 feet to about 40 feet, and can be telescopic to provide for an adjustable length. This allows lineman to stay a sufficient distance from potentially live voltage components. The end of a hot stick can be equipped with different components on the far end to perform different operations. For example, moveable or stationary hooks can be provided on the far end of the hot stick to allow a lineman to manipulate components at a distance.

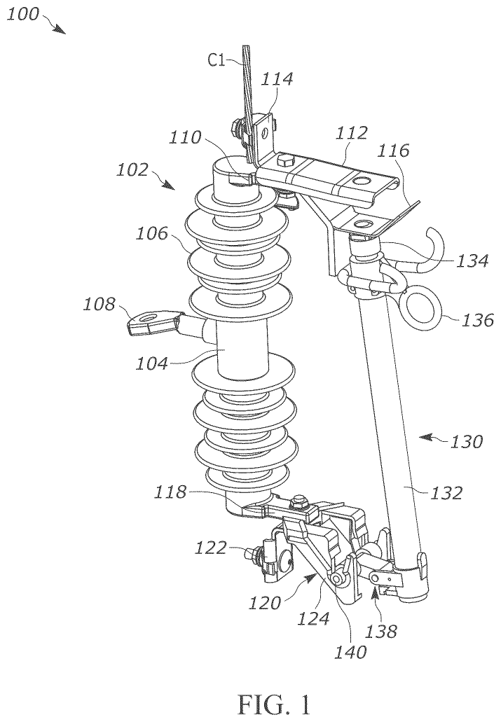

FIG. 1 shows an exemplary circuit interrupting device 100 having a cutout insulator 102. As depicted, the cutout insulator 102 includes an insulator body 104 having a plurality of watersheds 106. The insulator body 104 can be made from a suitable dielectric material. For example, the insulator can include thermal plastic, such as high-density polyethylene (HDPE) or PPE resin. Certain configurations can include thermal set material, such as epoxy or vinyl ester. The insulator body 104 can be molded, for example, injection molded, and the molding can include reinforcing fillers to enhance properties of the insulator body 104, such as, but not limited to, hydrophobic properties, UV stability, and track resistance.

A support bracket 108 extends from the insulator body 104. The support bracket 108 can be connected to a central region of the insulator body 104 and can include an opening to receive a mounting fastener. The support bracket 108 can connect the insulator body 104 to a support, such as a utility pole or crossarm, either directly or connected through one or more mounting brackets. The support bracket 108 or other mounting structure can be configured to mount the insulator body 104 at an angle so that a longitudinal axis of the insulator 102 extends at an oblique angle relative to a vertical axis as determined relative to the ground.

An upper bracket 110 extends from an upper portion of the insulator body 104. The upper bracket 110 can be connected to a hood 112 having a proximal portion and a distal portion. The proximate portion can include an upper terminal 114 that is configured to receive a supply conductor C1. The distal portion can include a hood contact 116 extending from the hood 112. The hood contact 116 can be biased away from the hood 112 by, for example, by a spring or through resilient member.

A lower bracket 118 extends from a lower portion of the insulator body 104. The lower bracket 118 connects to a hinge member 120. The hinge member 120 has a lower terminal 122 that receives a load conductor. The hinge member 120 also has a pivot connection. The pivot connection can include a pair of arms 124 having an outer hook defining a cradle. The support bracket 108, upper bracket 110, and lower bracket 118 can be electrically isolated form one another by the insulator body 104.

A fuse tube 130 is connected to the cutout insulator 102. The fuse tube 130 includes a fuse body 132. A fuse contact 134 extends from a first portion of the fuse tube body 132. The fuse contact 134 is configured to releasably engage the hood contact 116. The fuse tube 130 can contain various internal components depending on the fuse tube's 130 operational requirements. Other types of fuse devices, including dropout reclosers and sectionalizers, can also be used.

An upper engagement interface can also extend from the first portion of the fuse tube body 132. The upper engagement interface provides a contact point for a user to manipulate the fuse tube 130. In certain configurations, the upper engagement interface is configured to interact with a hot stick. In an exemplary embodiment, the upper engagement interface can include a ring 136 that extends outwardly from the fuse tube body 132.

A pivot 138 extends from a second portion of the fuse tube body 132 spaced from the first portion along a vertical axis. The pivot 138 is positioned and configured to be received in the hinge member 120 of the insulator body 102. The pivot 138 can include a trunnion member 140 which is received in the cradle of the insulator body 102 hinge. The trunnion member 140 can include a pair of opposing projections seated in the cradle to provide a rotatable connection between the fuse tube 130 and the cutout insulator 102.

During operation, a fuse positioned in the fuse tube 130 can blow due to an overcurrent condition. This can cause the fuse tube 130 to pivot and disconnect the fuse contact 134 from the hood contact 116. A user, such as a lineman, can then replace the fuse tube 130 and reconnect the device to permit power to be restored in the distribution system.

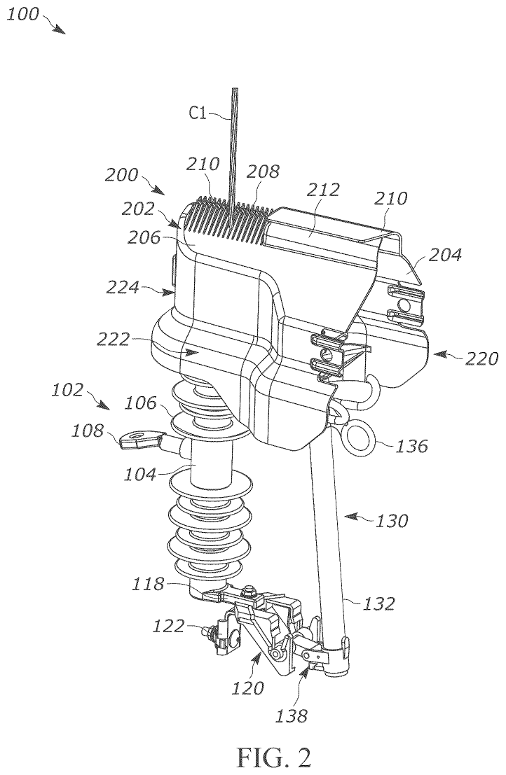

FIGS. 2-5 show an exemplary embodiment of a cover 200 that can be used to protect the circuit interrupting device 100. The cover 200 defines an interior and can be configured to fit around the insulator 102 and connect to the insulator body 104. An open front allows the fuse tube 130 to pivot and disconnect from the hood contact 116 as needed. The supply conductor C1 can extend through an opening in the cover 200. The cover 200 can be made from a single, unitary piece of material or can be made from multiple pieces connected together. Different materials can be used to make the cover 200, and in certain configurations the cover 200 is made from a non-conductive material.

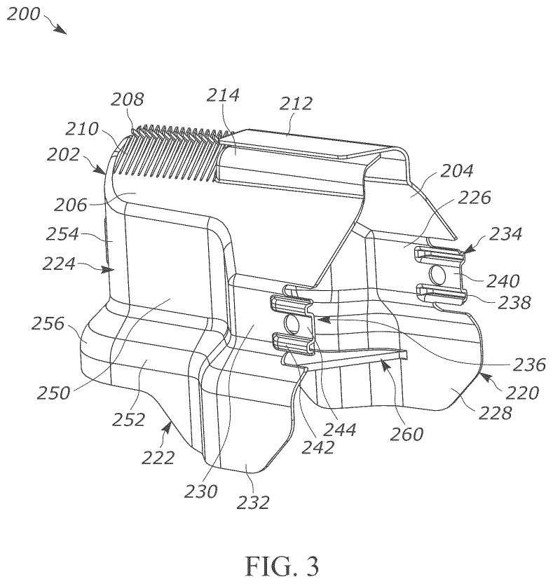

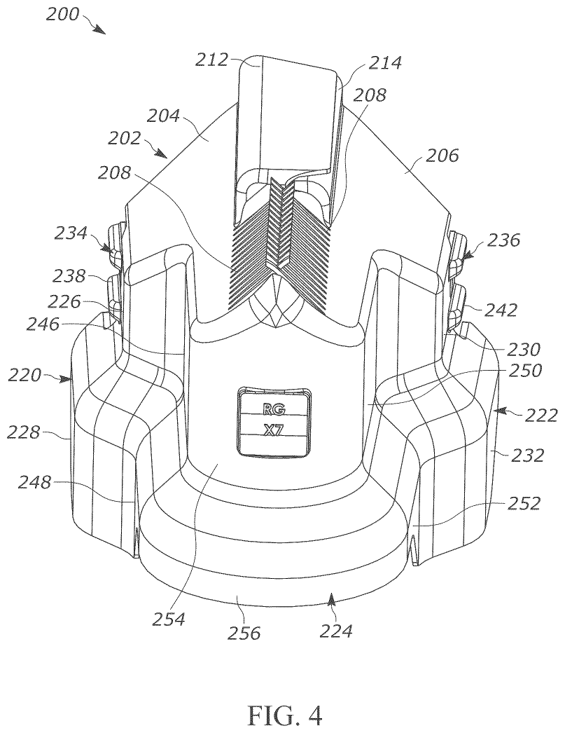

In certain configurations, as best shown in FIGS. 3 and 4, the cover 200 includes a top portion 202 having a first top wall 204 and a second top wall 206. The first and second top walls 204, 206 can extend from a rear of the cover 202 and be oriented at an oblique angle to one another to permit precipitation runoff from the cover 200. A first set of fingers 208 extend from the first top wall 204 and a second set of fingers 210 extend from the second top wall 206. The fingers 208 extend toward each other and intertwine. In certain configurations, the fingers 208, 210 can intertwine to leave less than a 0.125 inch (3.175 mm) gap between fingers. The fingers 208, 210 can also be flexible to provide openings for the conductor C1. The fingers 208 help prevent wildlife from invading the cover 200.

A first flap 212 extends from the first top wall 204 and a second flap 214 extends from the second top wall 206. The flaps 212, 214 are bent to cover an open slot in the top portion. The flaps can be resilient, so that the Conductor C1 can be maneuvered between the flaps 212, 214 during installation. Initially, the flaps 212, 214 can extend to form an open slot that receives the conductor C1 as the cover 200 is installed over the circuit interrupting device 100. This can enable the cover 200 to be installed by a hot stick without removal of the conductor C1, and the bent flaps 212, 214 can provide a closure that helps prevent wildlife from entering the cover 200 and can also help secure the cover 200 on the circuit interrupting device 100 by resisting pull out of the cover 200. In certain configurations, the flaps 212, 214 can be bent so that one flap extends at least partially over the other flap. In certain configurations, the fingers 208, 210 can extend all the way to the flaps 212, 214. In certain embodiments, the flaps 212, 214 can extend a certain distance along the top portion 202 to help balance the cover 200 after installation, e.g., to prevent or limit drooping or sliding of the cover 200 relative to the circuit interrupting device 100. For example, the flaps 212, 214 can extend a greater distance along the top portion 202 than the fingers 208, 210.

In certain configurations the cover includes an outer wall. The outer wall can include a first side portion 220, a second side portion 222, and a rear portion 224. The rear portion 224 can connect the first side portion 220 and the second side portion 222. The side portions 220, 222 and the rear portion 224 can have various sizes and shapes, and can include various rectilinear and curvilinear surfaces and edges depending on the desired application and characteristics of the cover 200.

In the illustrated configuration, as best shown in FIG. 3, the first side portion 220 can have a first front upper portion 226 and a first front lower portion 228. The second side portion 222 can have a second front upper portion 230 and a second front lower portion 232. The front upper portions 226, 230 can be spaced closer to a central plane of the cover 200 than the lower portion 228, 232 so that the front portion of the cover 200 is wider at the lower portions 228, 232. The width can extend in one or more steps or stages, and be transitioned by different curved or angled surfaces.

A first tab 234 extends from the first front upper portion 226 and a second tab 236 extends from the second front upper portion 230. Slots can be provided on either side of the tabs 234, 236 to provide flexibility to the tabs 234, 236. The tabs 234,236 can each include a pair of projections 238, 242 extending from a base 240, 244. An opening can be provided in the base 240, 244. The opening allows a hot stick to engage either side of the cover 200 to pull the cover 200 into place.

The first side portion 220 can have a first back upper portion 246 and a first back lower portion 248. The second side portion 222 can have a second back upper portion 250 and a second back lower portion 252. The back upper portions 248, 250 can be spaced closer to a central plane of the cover 200 than the lower portions 248, 252 so that the cover 200 is wider at the lower portions 248, 252. The width can extend in one or more steps or stages, and be transitioned by different curved or angled surfaces.

Additionally, the back portions 246, 248, 250, 252 can be positioned closer to the central plane of the cover 200 than the front portions 226, 228, 230, 232 so that the cover 200 narrows from the front toward the rear. One or more transition sections can be provided and can include angled or curved surfaces.

In the illustrated configuration, as best shown in FIG. 4, the rear portion includes an upper rear portion 254 and a lower rear portion 256. The upper rear portion 254 can have a curved outer surface. The upper rear portion 254 can be substantially cylindrical extending from the top portion 202. The lower rear portion 256 can have a curved outer surface. The lower rear portion 256 can extend further from the central plane than the upper rear portion 254. In certain embodiments the lower rear portion 256 can have varying widths, for example a bell configuration as shown in the illustrated configuration.

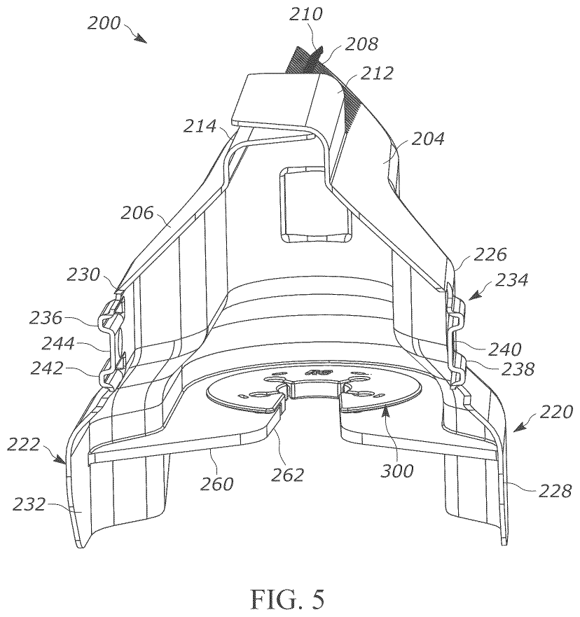

FIG. 5 shows an exemplary configuration of the interior of the cover 200. A base 260 extends between the first side portion 220 and the second side portion 222. The base 260 has a slot 262 that extends from the front of the cover 200 toward the rear portion 224. The slot 262 can be configured to fit around at least a portion of the insulator body 104. An insert 300 can be positioned in the interior of the cover 200 and connected to the base 260.

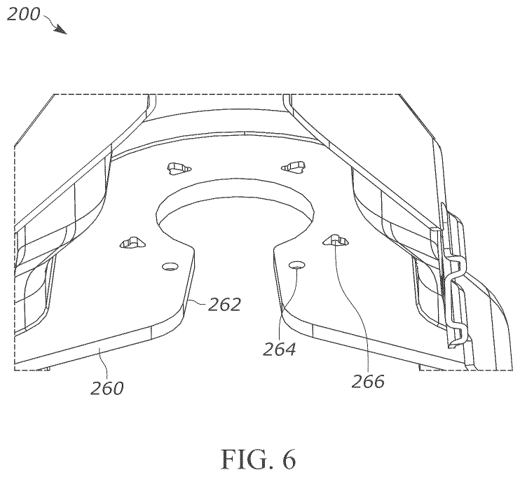

As best shown in FIG. 6, the base 260 can include a set of openings to receive and position the insert 300. The openings can include one or more boss openings 264 and one or more snap-fit connector openings 266. The insert 300 is accordingly removable from the base 260. The openings can accommodate different configurations of inserts 300, so that the same cover 200 can be used with different types and sizes of circuit interrupting devices 100. In other configurations, the insert 300 can be connected to the cover 200 with other mechanical fasteners or can be joined with an adhesive or through a molding process, for example an overmolding process.

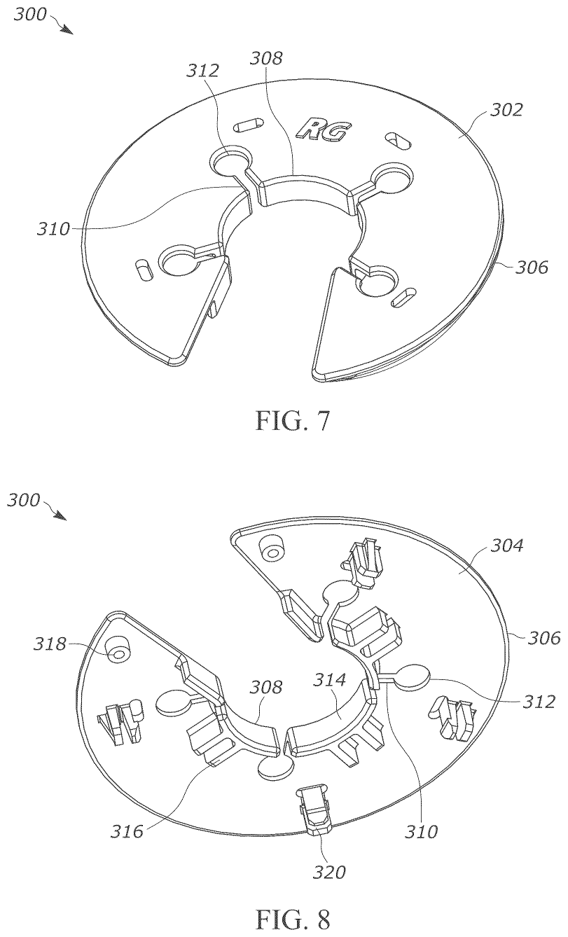

FIGS. 7 and 8 show an exemplary configuration of an insert 300 having an upper surface 302, a lower surface 304, an outer edge 306, and an inner edge 308. In certain configurations the insert 300 can include a substantially circular outer edge 306, and a substantially circular inner edge 308, though other configurations can be used. The inner edge 308 can define an inner aperture with a diameter that can be adjusted to receive different size fuse components, for example an insulator body 104.

A series of slots 310 and openings 312 can extend from the inner edge 308 to form discrete edge sections of the inner edge 308. These edge sections can provide flexibility to the inner edge 308, allowing it to securely engage the insulator body 104.

A projection 314 can extend from the lower surface from each section around the inner edge 308. One or more of the projections 314 can be supported by one or more ribs 316 to provide extra support to the projections 314. One or more bosses 318 extend from the lower surface 304 to help align the insert 300 with the base 260. One or more connectors 320, for example snap-fit connectors, can extend form the lower surface 304 to secure the insert 300 to the base 260. The connectors 320 and the bosses 318 can be adjusted or eliminated in different configurations.

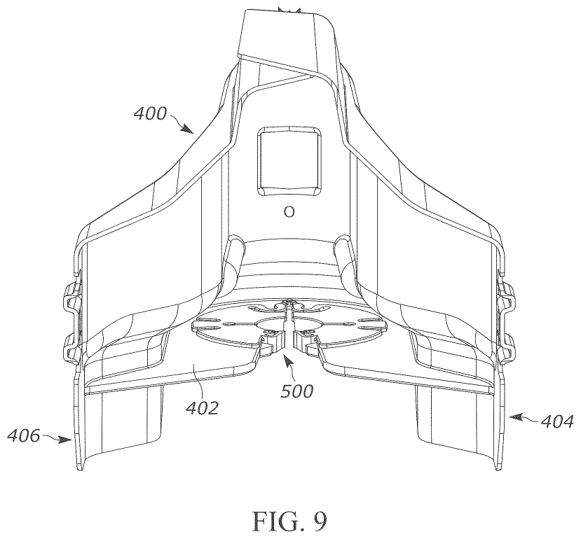

FIG. 9 shows another exemplary configuration of the interior of a cover 400 and an insert 500. The cover 400 has similar features to the cover 200 unless otherwise noted. A base 402 extends between the first side portion 404 and the second side portion 406. The insert 500 can be positioned in the interior of the cover 400 and connected to the base 402. In certain configurations, the base 402 can include one or more optional rib reinforcements, for example on an underside of the base 402.

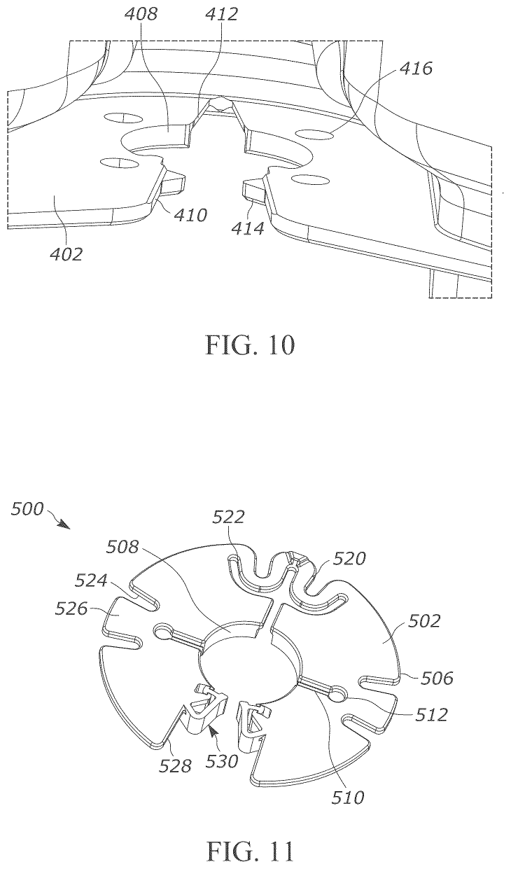

As best shown in FIG. 10, the base 402 includes a central aperture 408 configured to receive an insulator. The central aperture 408 can be at least partially defined by a circular outer wall. A forward slot 410 extends through the base from a front opening to the central aperture 408. A rear slot 412 extends from the central aperture 408 toward the rear portion of the cover 400. The side walls defining the forward slot 410 can be angled to give the forward slot 410 a wider front portion distal from the central aperture 408. The side walls defining the rear slot 412 can be angled to give the rear slot 410 a wider front portion proximate the central aperture 408. In certain configurations, one or more optional projections 414 can extend from the side walls into the forward slot 410. The projections can have a triangular configuration.

The base 402 can include a set of openings 416 to receive and position the insert 500. The insert 500 is accordingly removable from the base 402 in certain configurations. The openings 416 can accommodate different configurations of inserts 500, so that the same cover 400 can be used with different types and sizes of circuit interrupting devices 100. In other configurations, the insert 500 can be connected to the cover 400 with other mechanical fasteners or can be joined with an adhesive or through a molding process, for example an overmolding process.

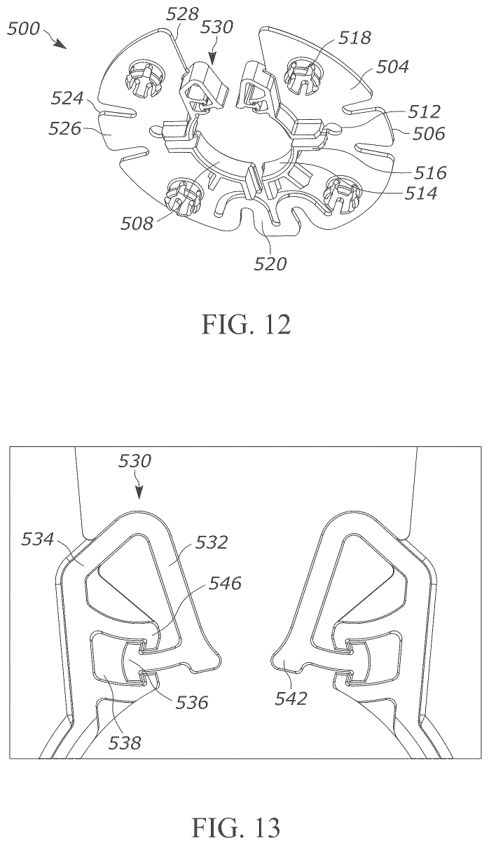

FIGS. 11 and 12 show an exemplary configuration of an insert 500 having an upper surface 502, a lower surface 504, an outer edge 506, and an inner edge 508. In certain configurations the insert 500 can include a substantially circular outer edge 506, and a substantially circular inner edge 508, though other configurations can be used. The inner edge 508 can define an inner aperture with a diameter that can be adjusted to receive different size fuse components, for example an insulator body 104.

A series of slots 510 and openings 512 can extend from the inner edge 508 to form discrete edge sections of the inner edge 508. These edge sections can provide flexibility to the inner edge 508, allowing it to securely engage the insulator body 104.

A projection 514 can extend from the lower surface from each section around the inner edge 508. One or more of the projections 514 can be supported by one or more ribs 516 to provide extra support to the projections 514. One or more connectors 518, for example snap-fit connectors, can extend form the lower surface 504 to secure the insert 500 to the base 402. The projections 514, ribs 516, and connectors 518 can be adjusted or eliminated in different configurations.

In certain configurations, a rear portion of the insert 500 includes a flexure 520. The flexure 520 can help reduce stress on the insert 500 during installation and attachment to a fuse device. In the illustrated embodiment the flexure 520 includes a substantially W-shaped body extending along the rear portion of the insert 500. A slot 522 can be positioned between the flexure 520 and the inner portion of the insert 500. While the W-shaped body is shown, other configurations of the flexure 520 can be used, including different sizes, shapes, location, and spacing.

In certain configurations, the outer edge 506 can include slots 524 extending into the body of the insert 500 to form a tab 526 on each side of the insert. The tabs 526 can offer stress relief to the outer edge 506 on the sides of the insert.

An opening 528 extends from a front portion of the insert 500 into the central aperture for receiving the insulator. In certain configurations, one or more resilient members 530 can extend into the opening 528. The resilient members can be displaced when the insert 500 is engaged with the insulator body and can spring back after connection to help retain the insulator in the inner aperture of the insert 500. The resilient members 530 can be positioned on each side of the opening 528 or on one side as needed.

FIG. 13 shows a detailed view of the illustrated configuration of the resilient members 530. The resilient members 530 can include a flexible arm 532 having a first end 534 connected to the body of the insert 500 and a second free end 536 moveably relative to the body. One or more bends can extend along the flexible arm 532 between the two ends 534, 536. The free end 536 can have a hook configuration that is captured in a notch 538 by a pair of opposing tines 540. The free end 536 is moveable in the notch 538 and is prevented from being dislodged by the tines 540.

In the illustrated configuration, the arms 532 extend into the opening 528 so that the engagement with an insulator will initially deform the arms 532, pressing the free end 536 into the notch 538. The arms 532 will then extend back out into the opening after the insulator has passed. Projections 542 on the arms 532 can help resist involuntary removal of an insulator from the insert 500. Different configurations for the resilient members can also be used.

Other configurations of inserts can be used as needed. For example, the inner diameter can be adjusted to be used with a different sized insulator body 104. Different materials can also be used to correspond with different material types of insulators. In certain configurations, the inserts can have a different hardness than the cover 200. In certain embodiments the inserts can be made from a material having a softer durometer than the cover 200 to help prevent damage to the insulator 102.

While an exemplary embodiment of the recloser is described in connection with a fuse cutout insulator and related components for a power distribution system, it will be readily apparent to one of ordinary skill in the art armed with the present specification that the components described herein can be applied to a multiplicity of fields and uses. In particular, the recloser can be used in connection with a power fuse or a sectionalizer. Likewise, the exemplary embodiments may be advantageous when coupling with a conductive blade to form an airbreak switch or used to hold other circuit make/break and sensing devices. The engagement interfaces can also be incorporated into other devices such as a fuse tube or other power distribution fuse components. Finally, one of ordinary skill in the art armed with the present specification will also understand that the present system may be easily modified to include different configurations, mechanisms, methods, and kits, which achieve some or all of the purposes of the present disclosure.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. A cover for a distribution system circuit interrupting device comprising:
a top portion;
an outer wall extending from the top portion, the outer wall defining an interior, the outer wall having a first side portion, a second side portion, a rear portion, and a front opening, the rear portion configured to receive a distribution system insulator and the front opening configured to permit rotation of a fuse device from the interior to an exterior of the outer wall; and
an insert positioned in the interior, the insert configured to releasably engage an insulator to connect the outer wall to the insulator.

2. The cover of claim 1, wherein the top portion includes a first top wall, first set of fingers extending from the first top wall, a second top wall, and a second set of fingers extending from the second top wall.

3. The cover of claim 1, wherein the top portion includes a first flap and a second flap, and wherein the first and second flaps are configured to cover a slot.

4. The cover of claim 1, wherein the insert includes a resilient section for engaging the insulator.

5. The cover of claim 1, wherein a base extends between the first side portion and the second side portion of the outer wall and the insert is received in the base.

6. The cover of claim 5, wherein the insert is secured to the base with a mechanical fastener.

7. The cover of claim 6, wherein the mechanical fastener is a snap-fit connector.

8. The cover of claim 6, wherein the base includes a central aperture, a forward slot extending from a front opening to the central aperture, and a rear slot extending from the central aperture toward the rear portion of the cover.

9. The cover of claim 1, wherein the insert has a hardness different from the outer wall.

10. The cover of claim 1, wherein the insert includes a flexure positioned in a rear portion of the insert.

11. The cover of claim 10, wherein the flexure has a W-shaped configuration.

12. The cover of claim 1, wherein the insert includes a resilient member extending into a front opening of the insert.

13. A cover for a distribution system circuit interrupting device comprising:
a top portion having a first top wall, a first set of fingers extending from the first top wall, a second top wall, a second set of fingers extending from the second top wall, a first flap extending from the first top wall, and a second flap extending from the second top wall, wherein the first and second flaps are configured to cover a slot; and
an outer wall extending from the top wall, the outer wall defining an interior, the outer wall having a first side portion, a second side portion, a rear portion, and a front opening, the rear portion configured to receive a distribution system insulator and the front opening configured to permit rotation of a fuse device from the interior to an exterior of the outer wall.

14. The cover of claim 13, wherein the first flap extends to the first set of fingers and the second flap extends to the second set of fingers.

15. The cover of claim 13, wherein the first set of fingers and second set of fingers intertwine to leave less than a 0.125 inch gap.

16. An insert for a distribution system circuit interrupting device comprising:
an upper portion having a planar portion extending in a first plane;
a lower portion having a planar portion extending in a second plane opposite the first plane;
an outer edge extending between the upper portion and the lower portion; and
an inner edge extending between the upper portion and the lower portion,
wherein the lower portion is configured to engage a support of a fuse device, and
wherein the inner edge defines an aperture configured to receive an insulator body of a fuse device.

17. The insert of claim 16, further comprising a snap-fit connector extending from the lower portion to secure the lower portion to the fuse device.

18. The insert of claim 16, further comprising a flexure spaced from the central aperture.

19. The insert of claim 16, further comprising a resilient member extending into a front opening.

20. The insert of claim 19, wherein the resilient member includes a moveable arm and the moveable arm includes a free end with a hook portion moveable in a notch.
